(19) United States
(12) Patent Application Publication
(10) Pub. No.: US 2016/0186924 A1
(43) Pub. Date: Jun. 30, 2016

(54) Clamping Device

(71) Applicant: Silvana Tracey, West Clandon (GB)

(72) Inventor: Silvana Tracey, West Clandon (GB)

(21) Appl. No.: 14/910,861

(22) PCT Filed: Aug. 6, 2014
(86) PCT No.: PCT/GB14/52409

§ 371 Date: Feb. 8, 2016

(30) Foreign Application Priority Data
Aug. 7, 2013 (GB) 1314169.2

(51) Int. Cl. F16M 13/02; F16B 45/00; F16B 2/10; F16B 47/00; A41G 5/00; A45D 44/14

(52) U.S. Cl. CPC F16M 13/022; A41G 5/004; A45D 44/14; F16B 2/10; F16B 47/00; F16B 45/00

(57) ABSTRACT

A clamping device (10) includes two elongate jaws (12, 13) which can be clamped together by a suitable closure device (30), and retained in the clamped state. At least one of the jaws can comprise a formation for the positioning of a hairpiece between the jaws.

### FIELD

Embodiments described herein relate to a clamping device for hairpieces, particularly, but not exclusively, for part-head hair extensions.

### BACKGROUND

Hair extensions are increasing in popularity, to enhance volume and/or length to the existing natural hair of a user. They can also be used to add contrasting or complementing colour effects.

Hair extensions can be permanently bonded to hair, or can be temporarily fixed. Temporary extensions are becoming popular, because they can be affixed by users without long-term commitment, and can be removed and/or replaced as the user wishes. Many temporary extensions are affixed by means of a comb or clip.

Extensions are, during use, subject to the same environmental effects as would be imposed on the user's own hair. As such, grease, air-borne pollution, water and fumes can have an impact on the condition of the hair of an extension. Since extensions can be relatively expensive, it is highly desirable to enable care of an extension, in the same way that a user might care for his/her own hair.

It would be undesirable to care for an extension while deployed on the user's head. This would be likely to lead to damage either to the extension or to the hair to which the extension has been fixed. However, extensions are somewhat difficult to handle when not deployed, and are susceptible to being tangled or dropped. The fixing comb (if supplied) does not provide particularly adequate purchase, to enable a user to hold the extension while brushing, washing or drying the extension piece.

It is thus desirable to improve the facility for care of hair extensions.

### SUMMARY

The described embodiments provide a device for the clamping of a hairpiece comprising: first and second elongate jaws, each jaw having a clamping surface; and a closure device connecting the first and second elongate jaws and allowing relative movement of the jaws between an open position and a closed position; wherein the closure device provides a clamping force between the respective clamping surfaces, urging the elongate jaws together.

The described embodiments allow a user to wash, style and store clamped products and in particular hair extensions.

Other features and advantages of the invention will be apparent from the following detailed description and from the appended claims.

### DRAWINGS

Embodiments will now be described by way of example with reference to the accompanying drawings in which:
FIG. 1 is a side elevation of a clamping device in accordance with a described embodiment, the device being in an engaged condition;

FIG. 2 is an end elevation of the clamping device, in the engaged condition;

FIG. 3 is an end elevation of the clamping device, in a disengaged condition;

FIG. 4 is a side elevation of a clamping jaw of the clamping device, showing clamping formations;

FIG. 5 is a cross section of the clamping jaw shown in FIG. 4, along a line A-A as indicated;

FIG. 6 is a perspective view of a further embodiment in accordance with the present disclosure in a partially closed configuration;

FIG. 7 is a further perspective view of the embodiment of FIG. 6 in a fully open configuration; and

FIG. 8 is a rear perspective view of the embodiment of FIG. 6 in a fully open configuration.

### DESCRIPTION

According to a first aspect of the present disclosure is a device for the clamping of a hairpiece comprising: first and second elongate jaws, each jaw having a clamping surface; and a closure device connecting the first and second elongate jaws and allowing relative movement of the jaws between an open position and a closed position; wherein the closure device provides a clamping force between the respective clamping surfaces, urging the elongate jaws together.

The jaws may be of substantially any shape and cross-section. The jaws may not be elongate.

The closure device may comprise a connector.

A connector may prevent the two jaws from entirely separating and may limit or restrict the movement of the jaws relative to each other. A connector may permit the two jaws to rotate or translate relative to each other. A connector may allow the two clamping surfaces to approach each other and move away from each other. The connector may allow the jaw to move between an open position and a closed position.

An open position may be one in which the two clamping surfaces are closest. The two clamping surfaces may be touching. Alternatively, a small gap may be present between the two clamping surfaces.

The connector may comprise a joint.

The connector may consist of a joint. The connector may comprise or consist of a plurality of joints.

The closure device may comprise a biasing device.

A biasing device may act to provide a clamping force between the respective clamping surfaces, urging the elongate jaws together. The biasing device may provide a clamping force between the respective clamping surfaces regardless of the relative position of the clamping surfaces. Alternatively, the biasing device may provide a clamping force between the respective clamping surfaces only when the clamping surfaces are in a closed position, or are near a closed position.

The biasing device may comprise at least one magnet.

A biasing device may comprise a single magnet attracted to a magnetic material located on the other jaw. Alternatively, a biasing device may comprise at least one pair of magnets, with opposite poles located on each jaw so as to exert a clamping force on the jaws.

Further examples of a biasing device are, but are not limited to: a leaf spring, a coil spring, a piston, a friction fit between the two jaws, Velcro™, a tie, a clip or a popper.

The closure device may comprise an engagement mechanism moveable between an engaged condition and a disengaged condition corresponding to the closed position and the open position of the jaws, respectively, such that, in the engaged condition, the first and second elongate jaws are urged together so as to impose the clamping force between the respective clamping surfaces, and, in the disengaged condition, the elongate jaws can be parted to allow placement and/or removal of a hairpiece between the clamping surfaces.

Further according to an embodiment disclosed herein is a device for the clamping of a hairpiece comprising first and second jaws, each jaw having a clamping surface; and an engagement mechanism moveable between an engaged condition and a disengaged condition, such that, in the engaged condition, the first and second elongate jaws are urged together so as to impose a clamping force between the respective clamping surfaces, and, in the disengaged condition, the elongate jaws can be parted to allow placement and/or removal of a hairpiece between the clamping surfaces.

An engagement mechanism may comprise a hinge, the hinge being lockable in the engaged condition to impose a clamping force between the clamping surfaces of the jaws.

The hinge may comprise a retaining clip, to retain the hinge in the engaged condition.

The respective clamping surfaces may be substantially planar, so that, in the engaged condition, the clamping surfaces are substantially parallel and juxtaposed.

At least one of the clamping surfaces may comprise a positioning formation, for the positioning of a hairpiece grip before clamping thereof.

The positioning formation may comprise a groove.

The groove may extend substantially the length of the elongate jaw.

The device may further comprise attachment means, for removable attachment of the device to a work surface in use.

The attachment means may comprise one or more suction cups.

The device may further comprise a hook to provide a facility for hanging the device over a suitable projection, in use.

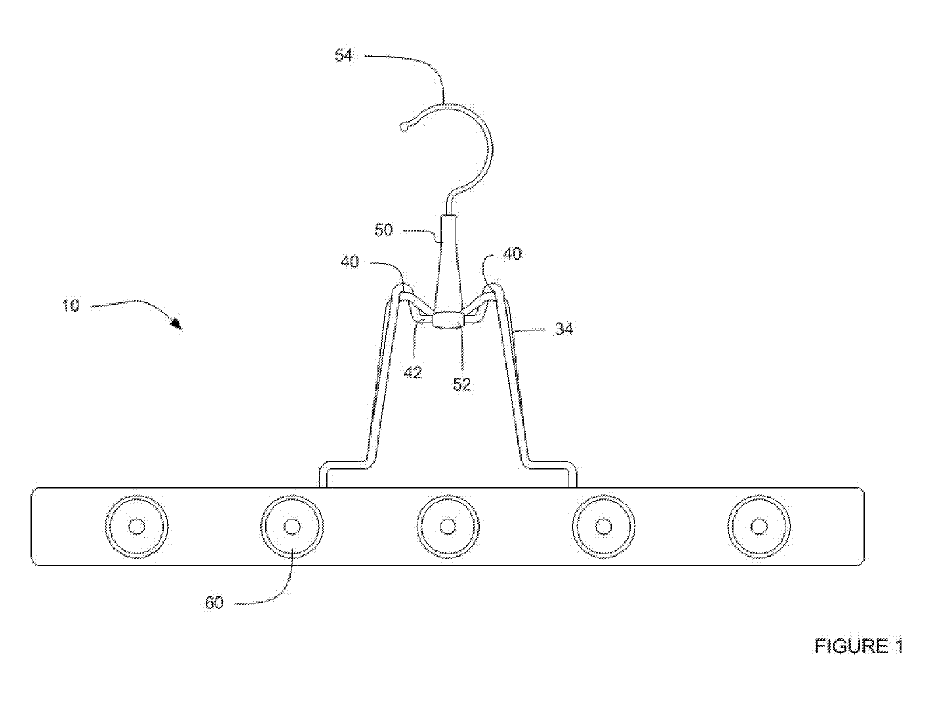

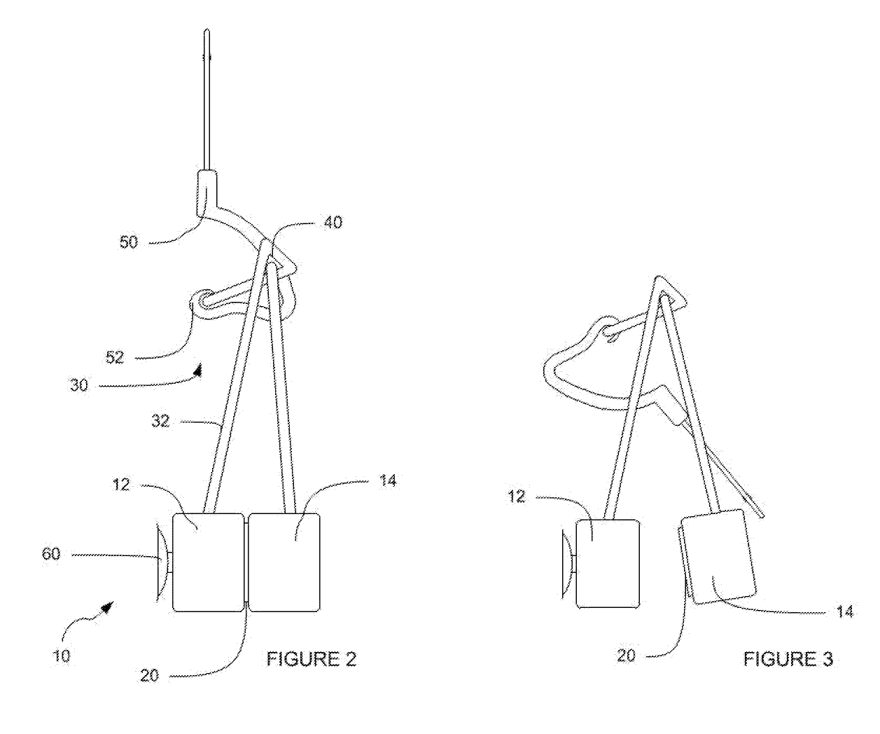

As shown in FIGS. 1 and 2, a clamping device 10 comprises a pair of elongate clamping jaws 12, 14, of substantially rectangular cross section, aligned to reside alongside each other. Each jaw 12, 14 has a clamping surface, the clamping surfaces in use opposing each other to define a clamping gap which closes when the device 10 is in an engaged condition and opens when the device 10 is in a disengaged condition.

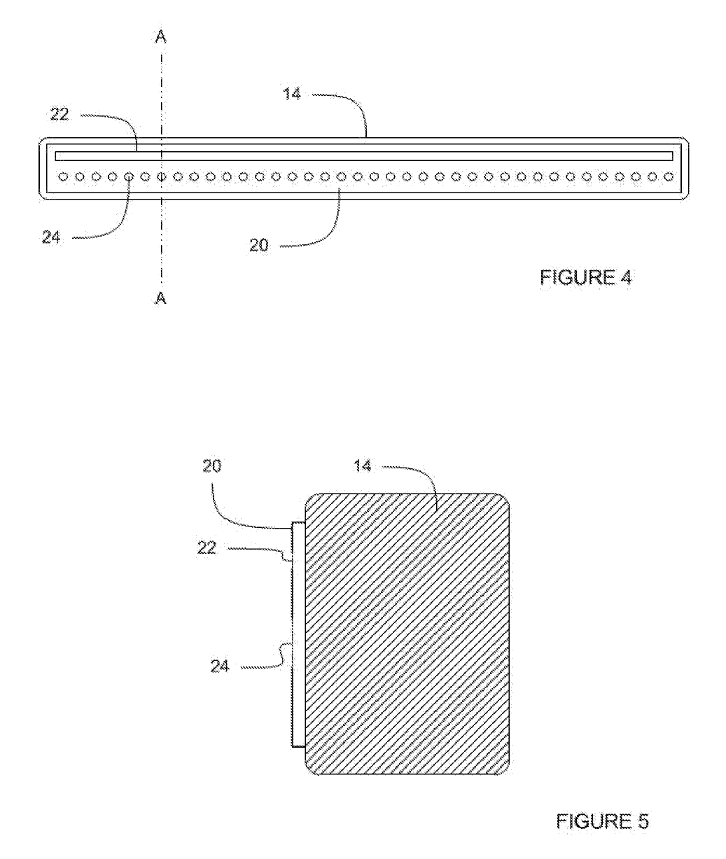

A positioning plate 20 is affixed to the clamping surface of one of the jaws 14. This positioning plate 20 is illustrated in further detail in FIG. 4. The positioning plate 20 defines a longitudinal slot 22, extending substantially along its full length, and thus substantially fully along the length of the clamping surface. The positioning plate 20 also has a plurality of positioning apertures 24 defined therein. The apertures 24 are generally circular, and are aligned in a row parallel to the slot 22, again, along substantially the full length of the positioning plate 20.

The positioning slot 22 and the positioning apertures 24 provide relief features against which hairpieces can be positioned. Many hairpieces are supplied mounted on combs—a comb will engage readily with one or other of the positioning slot 22 and the positioning apertures 24.

An engagement clip 30 is provided, to engage the two jaws 12, 14 with each other. The engagement clip 30 comprises two wire clip pieces 32, 34, which are intertwined to form a hinge.

As such, a first of the two wire clip pieces 32 is composed of a length of wire formed in such a manner as to mount at both its ends into a side face of the jaw 12 perpendicular to the clamping face of that jaw, and in a mid-section between the two ends is looped over to define two interlock loops 40 and a generally straight portion therebetween 42, the straight portion 42 being substantially parallel to the jaw 12.

A second of the two wire clip pieces 34 is composed of a length of wire formed in such a manner as to mount at both its ends into a side face of the jaw 14 perpendicular to the clamping face of that jaw, and in a mid-section between the two ends is threaded through the two interlock loops 40 of the first wire clip piece 32. In a portion of the second wire clip piece 34 between the two interlock loops, there is a generally U-shaped formation, the opening of the U facing away from the jaw 14.

A clip 50, of a relatively flexible resilient material (such as plastics) is generally hook-shaped. At one end, the clip 50 has a lip 52 which engages over the straight portion of the first wire clip piece 32. A mid-section of the clip 50 defines a camming surface 52, suitable to cam over the U-shaped section, and to lock in place to hold the two wire clip pieces in a position whereby the two jaws 12, 14 are urged together. The U-shaped section, by its shape, provides a formation which readily elastically deforms under the application of a force associated with the camming of the clip over the U-shaped section, which itself assists in retaining the clip 50 in place.

The other end of the clip 50 is equipped with a coat-hanger style hook formation 54, so that the device 10 can be hung from a coat hook in use.

As shown in FIG. 3, release of the clip 50 from the locked position causes the force urging the two jaws together to be removed. This then enables the jaws 12, 14 to be separates, as desired.

A series of suction cups 60 are attached to an outer face of the first jaw 12, that is, the face opposite the clamping face of that jaw. The suction cups 60 can be used to affix the device 10 to a work-surface, or a wall or door, thus freeing both hands of the user for the care of a hairpiece clamped in the device 10.

The described embodiment envisages that the jaws 12, 14 are composed of wood, selected for its relatively high strength to mass ratio. Other materials (such as plastics materials) could be used instead. Likewise, while the engagement clip 30 is described as being of wire (and, by inference, of a metallic material), plastics materials could be substituted. Indeed, materials selection is not a key element of this disclosure.

The formations of the positioning plate 20 are merely exemplary. Other formations (or no formations at all) may be provided. For instance, the formations may be selected in anticipation of the construction of hairpieces with which the device 10 is to be used.

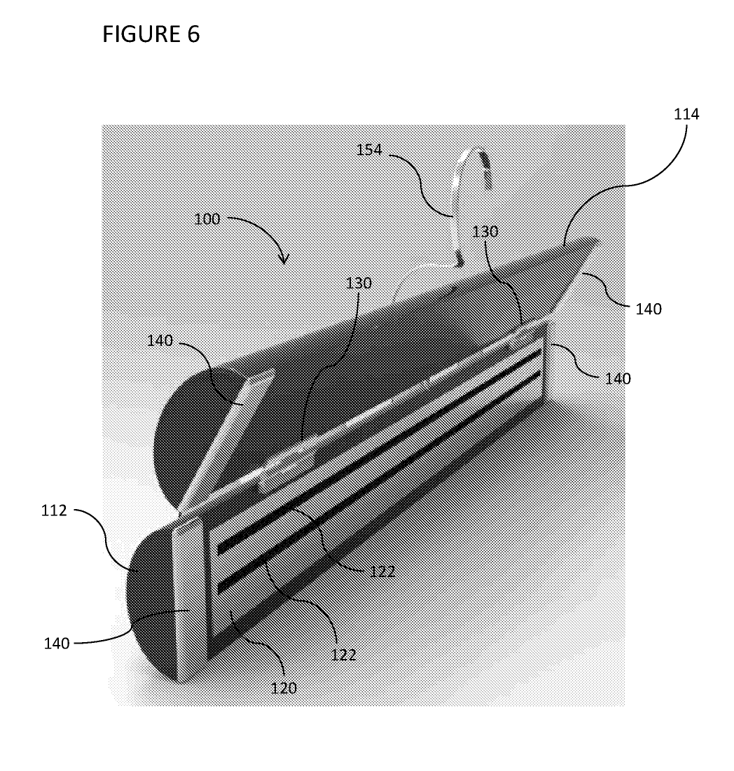

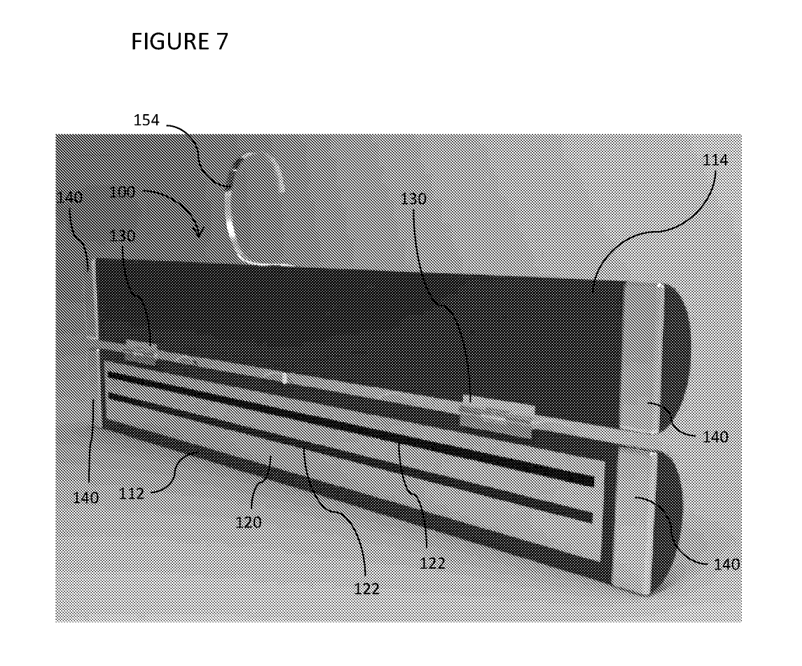

FIG. 6 shows a further embodiment according to the present disclosure. The embodiment of FIG. 6 shows a device 100 comprising a pair of elongate clamping jaws 112, 114 of substantially semi-circular cross section. The jaws 112, 114 are substantially parallel. Each jaw 112, 114 has a clamping surface, the clamping surfaces in use opposing each other to define a clamping gap which closes (either entirely or partially) when the device 100 is in a closed position and opens when the device 100 is in an open position. The clamping surfaces of the present embodiment comprise the flat side of the substantially semi-circular prism that forms each jaw 112, 114. A positioning plate 120 is affixed to the clamping surface of one of the jaws 112. This can be either jaw 112, 114. The positioning plate 120 defines two longitudinal slots 122, extending substantially along its full length, and thus substantially fully along the length of the clamping surface.

The positioning slots 122 provide relief features against which hairpieces can be positioned. Many hairpieces are supplied mounted on combs—a comb will engage readily with one or other of the positioning slots 122.

The two jaws 112, 114 of the embodiment of FIG. 6 are connected along one of the long edges of the respective clamping surfaces. The two jaws 112, 114 are pivotally connected by means of joints 130. There may be any number of joints 130. The joints 130 permit the two jaws 112, 114 to rotate relative to each other and thus the clamping surfaces to open and close.

On each end of both jaws 112, 114 is a magnet 140. The magnets 140 are arranged such that when the jaws 112, 114 are closed a magnet 140 on each of the jaws approaches or abuts a magnet of the opposite polarity on the neighbouring jaw. The magnetic force generated may act to maintain the jaws in a closed position, or resist movement in a disengaging or opening direction. The magnets 140 are chosen to be sufficiently strong to ensure that unintentional disengaging of the jaws 112, 114 during use does not occur, but not so strong as to prevent a user from being able to manually open the jaws to insert or remove a hairpiece, when required.

In alternative embodiments, the magnets may be integrated into the two jaws, either as a component flush with the surface, or a magnetised region of each jaw.

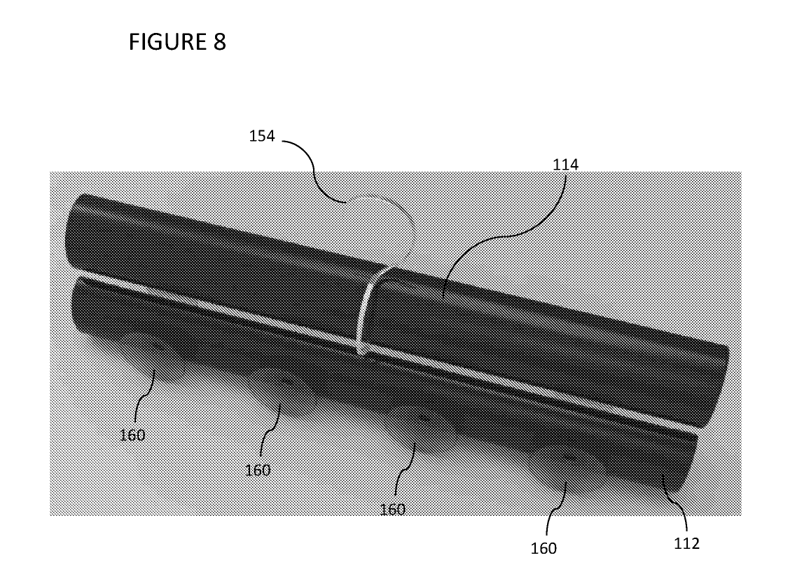

Turning to FIG. 8, a coat-hanger style hook 154 is provided extending from the joint-edge. The coat-hanger style hook is shaped so as to avoid interference with either of the jaws 112, 114 when in a closed or open state. The hook 154 allows a user to hang the device 100 from a rail during use.

A series of suction cups 160 are attached to an outer face of one of the jaws 112, that is, the face opposite the clamping face of that jaw. In the embodiment of FIG. 6, that is one of the rounded surfaces of the jaws 112, 114. The suction cups 160 can be used to affix the device 100 to a work-surface, or a wall or door, thus freeing both hands of the user for the care of a hairpiece in the device 100 or to allow a user to arrange the hairpiece before being inserted in the device.

While certain embodiments have been described, these embodiments have been presented by way of example only, and are not intended to limit the scope of the inventions. Indeed, the novel methods, devices, and systems described herein may be embodied in a variety of other forms; furthermore, various omissions, substitutions and changes in the form of the methods, devices, and systems described herein may be made without departing from the spirit of the inventions. The accompanying claims and their equivalents are intended to cover such forms or modifications as would fall within the spirit and scope of the inventions.

1. A device for the clamping of a hairpiece comprising:
first and second elongate jaws, each jaw having a clamping surface; and
a closure device connecting the first and second elongate jaws and allowing relative movement of the jaws between an open position and a closed position;
wherein the closure device provides a clamping force between the respective clamping surfaces, urging the elongate jaws together.

2. The device of claim 1, wherein the closure device comprises a connector.

3. The device of claim 2, wherein the connector comprises a joint.

4. The device of claim 1, wherein the closure device comprises a biasing device.

5. The device of claim 4, wherein the biasing device comprises at least one magnet.

6. The device of claim 1, wherein the closure device comprises an engagement mechanism moveable between an engaged condition and a disengaged condition corresponding to the closed position and the open position of the jaws, respectively, such that, in the engaged condition, the first and second elongate jaws are urged together so as to impose the clamping force between the respective clamping surfaces, and, in the disengaged condition, the elongate jaws can be parted to allow placement and/or removal of a hairpiece between the clamping surfaces.

7. The device of claim 6, wherein the engagement mechanism comprises a hinge, the hinge being lockable in the engaged condition to impose a clamping force between the clamping surfaces of the jaws.

8. The device of claim 7 wherein the hinge comprises a retaining clip, to retain the hinge in the engaged condition.

9. The device of claim 1, wherein the respective clamping surfaces are substantially planar, so that, in the closed position, the clamping surfaces are substantially parallel and juxtaposed.

10. The device of claim 9 wherein at least one of the clamping surfaces comprises a positioning formation, for the positioning of a hairpiece grip before clamping thereof.

11. The device of claim 10 wherein the positioning formation comprises a groove.

12. The device of claim 11 wherein the groove extends substantially the length of the elongate jaw.

13. The device of claim 1, further comprising an attachment, for removable attachment of the device to a work surface.

14. The device of claim 13 wherein the attachment comprises one or more suction cups.

15. The device of claim 1, further comprising a hook to provide a facility for hanging the device over a suitable projection.

16. The device of claim 3, wherein the closure device comprises a biasing device.

17. The device of claim 6, wherein the respective clamping surfaces are substantially planar, so that, in the closed position, the clamping surfaces are substantially parallel and juxtaposed.

18. The device of claim 7, wherein the respective clamping surfaces are substantially planar, so that, in the closed position, the clamping surfaces are substantially parallel and juxtaposed.

19. The device of claim 5, further comprising an attachment for removable attachment of the device to a work surface.

20. The device of claim 19, wherein the attachment comprises one or more suction cups.
